(19) United States
(12) Patent Application Publication
(10) Pub. No.: US 2021/0023839 A1
(43) Pub. Date: Jan. 28, 2021

(54) CONTINUOUS INKJET PRINTER INCLUDING PRINTHEAD TRANSLATION MECHANISM

(71) Applicant: Eastman Kodak Company, Rochester, NY (US)

(72) Inventors: Terry Anthony Wozniak, Springfield, OH (US); Richard Mazur, Ridgefield, CT (US); Daniel B. Denofsky, Dayton, OH (US)

(21) Appl. No.: 16/523,024

(22) Filed: Jul. 26, 2019

(51) Int. Cl. B41J 2/07; B41J 2/02

(52) U.S. Cl. CPC B41J 2/07; B41J 2002/022; B41J 2/02

(57) ABSTRACT

A continuous inkjet printer includes a linear printhead having a cross-track printhead width that is wider than a cross-track image width. The linear printhead is characterized to determine an image quality level as a function of cross-track position. A segment of the linear printhead is designated wherein the image quality level within the designated segment of the linear printhead is acceptable. A translation mechanism is used to translate the linear printhead relative to the receiver medium such that the designated segment of the linear printhead is aligned with a region on the receiver medium where the image content is to be printed, and the image content is printed on the receiver medium using the designated segment of the linear printhead.

### CROSS-REFERENCE TO RELATED APPLICATIONS

Reference is made to commonly assigned, co-pending U.S. patent application Ser. No. ______ (Docket K002296), entitled: “Method for printing narrow image content”, by Wozniak et al.; and to commonly assigned, co-pending U.S. patent application Ser. No. ______ (Docket K002299), entitled: “Method for printing using sequence of printhead segments”, by Wozniak et al., each of which is incorporated herein by reference.

### FIELD OF THE INVENTION

This invention generally relates to a digital inkjet printing system, and more particularly to a method for printing image content having a cross-track image width that is narrower than the width of the printhead.

### BACKGROUND OF THE INVENTION

Continuous inkjet printing allows economical, high-speed, high-volume print reproduction. In this type of printing, a continuous web of paper or other print media material is fed past one or more printing subsystems that form images by applying one or more colorants onto the print media surface. In each printing subsystem, finely controlled dots of ink are rapidly and accurately propelled from an array of nozzles in a printhead onto the surface of a moving print media, with the web of print media often coursing past the printhead at speeds measured in hundreds of feet per minute.

In some applications, the image data being printed by the inkjet printing system may have a cross-track width which is substantially smaller than the printing width of the printhead (e.g., when barcodes or address labels). Over time, printing defects may be observed corresponding to particular cross-track positions on the printhead. When the printing defects occur within the region corresponding to the image content and exceed some threshold level of objectionability, it is necessary to remove the printhead from the printer system 20 for servicing or replacement. This can result in significant costs and delays which can impact productivity and profitability.

There remains a need for an improved inkjet printing system which can extend the time interval between the times when the printhead must be serviced.

### SUMMARY OF THE INVENTION

The present invention represents a continuous inkjet printer, including:

a linear printhead having an array of ink nozzles extending in a cross-track direction;

a receiver medium transport system for transporting a receiver medium past the linear printhead in an in-track direction;

a translation mechanism for translating the linear printhead relative to the receiver medium in the cross-track direction;

an image source providing image content having a cross-track image width;

a data processing system; and

a memory system communicatively connected to the data processing system and storing instructions configured to cause the data processing system to implement a method for controlling the continuous inkjet printer, wherein the method includes:
a) characterizing the linear printhead to determine an image quality level as a function of cross-track position, wherein the linear printhead has a cross-track printhead width that is wider than the cross-track image width;
b) designating a segment of the linear printhead having a cross-track segment width at least as large as the cross-track image width, wherein the image quality level within the designated segment of the linear printhead is acceptable;
c) using the translation mechanism to translate the linear printhead relative to the receiver medium such that the designated segment of the linear printhead is aligned with a region on the receiver medium where the image content is to be printed; and
d) controlling the linear printhead and the receiver medium transport system to print the image content provided by the image source on the receiver medium using the designated segment of the linear printhead.

This invention has the advantage that the life of the printhead can be extended before it is necessary to service or replace the printhead by repositioning the printhead when the image quality drops to an unacceptable level.

It has the additional advantage that it can enable a higher yield in the printhead manufacturing process because the printhead can be positioned to avoid using printhead segments that have an unacceptable image quality level, thereby rendering a printhead that may have needed to be discarded to be usable.

### BRIEF DESCRIPTION OF THE DRAWINGS

FIG. 1 is a simplified block schematic diagram of an exemplary continuous inkjet system in accordance with the present invention;

FIG. 2 shows an image of a liquid jet being ejected from a drop generator and its subsequent break off into drops with a regular period;

FIG. 3 shows a cross sectional of an inkjet printhead of the continuous liquid ejection system in accordance with the present invention;

FIG. 4 shows a first example embodiment of a timing diagram illustrating drop formation pulses, the charging electrode waveform, and the break-off of drops;

FIG. 5 shows a top view of an exemplary printhead assembly including a staggered array of jetting modules;

FIG. 6 is a flowchart of a method for printing image content on an inkjet printer system according to an exemplary embodiment;

FIG. 7 illustrates printing image content onto a receiver medium using a printhead segment;

FIG. 8 is a flowchart illustrating additional details of the characterize printhead step of FIG. 6 according to one exemplary arrangement;

FIG. 9 illustrates an exemplary test target;

FIG. 10 illustrates an exemplary image quality function;

FIG. 11 is a flowchart illustrating additional details of the characterize printhead step of FIG. 6 according to another exemplary arrangement;

FIG. 12 illustrates an exemplary user interface for entering information pertaining to the image quality level;

FIG. 13 is a flowchart of a method for printing image content on an inkjet printer system according to an alternate embodiment; and

FIG. 14 is a high-level diagram showing the components of a system for processing images in accordance with the present invention.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. Unless otherwise explicitly noted or required by context, the word “or” is used in this disclosure in a non-exclusive sense.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention relate to a printhead or printhead components typically used in continuous inkjet printing systems. However, many other applications are emerging which use printheads to emit liquids (other than inks) that need to be finely metered and deposited with high spatial precision. As such, as described herein, the terms “liquid” and “ink” refer to any material that can be ejected by the printhead or printhead components described below.

Within the context of the present disclosure, the terms “operator,” “user” and “human observer” are used interchangeably.

The present invention is well-suited for use in roll-fed inkjet printing systems that apply colorant (e.g., ink) to a web of continuously moving print media. In such systems a printhead selectively moistens at least some portion of the media as it moves through the printing system, but without the need to make contact with the print media. While the present invention will be described within the context of a roll-fed inkjet printing system, it will be obvious to one skilled in the art that it could also be used for other types of printing systems as well.

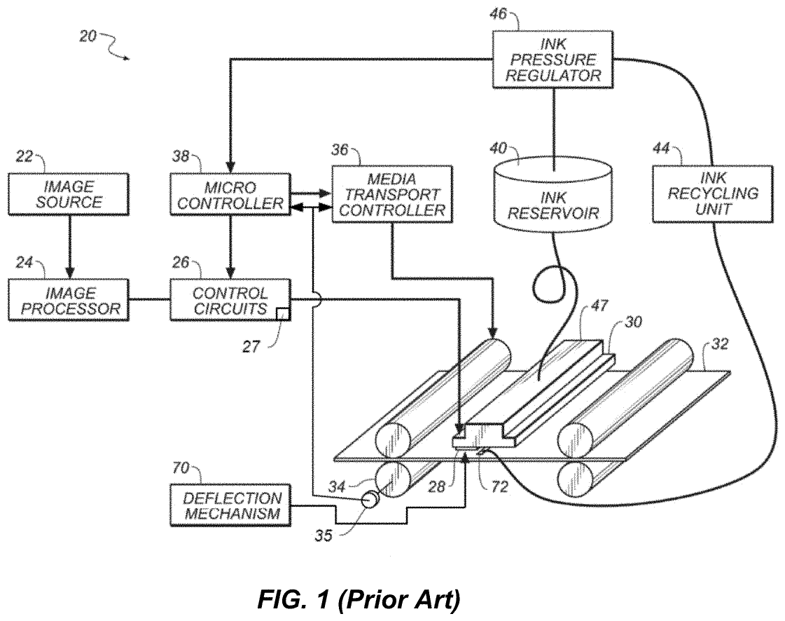

Referring to FIG. 1, a continuous printing system 20 includes an image source 22 such as a scanner or computer which provides raster image data, outline image data in the form of a page description language, or other forms of digital image data. This image data is converted to half-toned bitmap image data by an image processing unit (image processor) 24 which also stores the image data in a digital memory. A plurality of drop forming transducer control circuits 26 reads data from the image memory and apply time-varying electrical pulses to a drop forming transducers 28 that are associated with one or more nozzles of a printhead 30. These pulses are applied at an appropriate time, and to the appropriate nozzles, so that drops formed from a continuous ink jet stream will form spots on a print medium 32 in the appropriate position designated by the data in the image memory.

Print medium 32 is moved relative to the printhead 30 by a print medium transport system 34, which is electronically controlled by a media transport controller 36 in response to signals from a speed measurement device 35. The media transport controller 36 is in turn controlled by a micro-controller 38. The print medium transport system 34 transports the print medium 32 past the printhead 30 in an in-track direction. The print medium transport system 34 shown in FIG. 1 is a schematic only, and many different mechanical configurations are possible. For example, a transfer roller could be used in the print medium transport system 34 to facilitate transfer of the ink drops to the print medium 32. Such transfer roller technology is well known in the art. In the case of page width printheads, it is most convenient to move the print medium 32 along a media path past a stationary printhead. However, in the case of scanning print systems, it is often most convenient to move the printhead along one axis (the sub-scanning direction) and the print medium 32 along an orthogonal axis (the main scanning direction) in a relative raster motion.

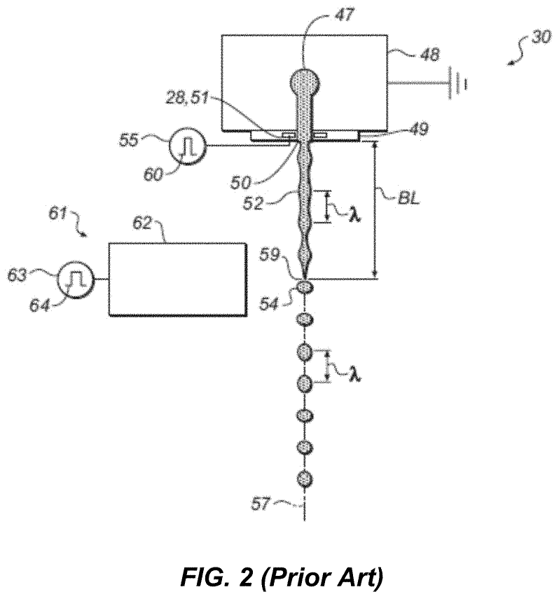

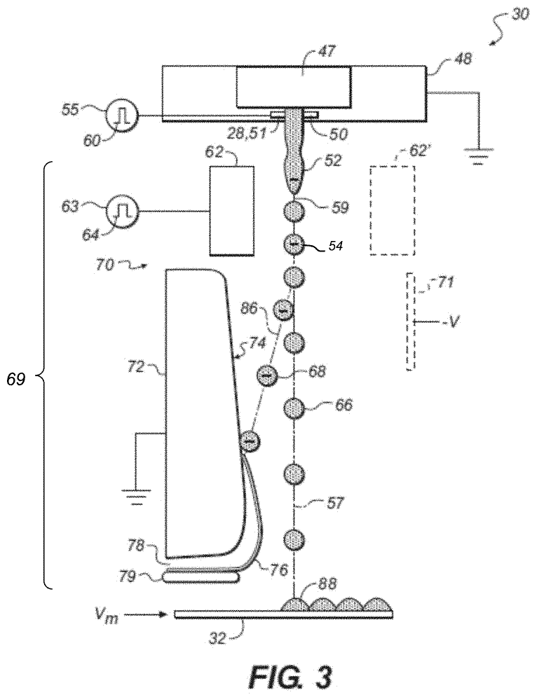

Ink is contained in an ink reservoir 40 under pressure. In the non-printing state, continuous ink jet drop streams are unable to reach print medium 32 due to an ink catcher 72 that blocks the stream of drops, and which may allow a portion of the ink to be recycled by an ink recycling unit 44. The ink recycling unit 44 reconditions the ink and feeds it back to the ink reservoir 40. Such ink recycling units are well known in the art. The ink pressure suitable for optimal operation will depend on a number of factors, including geometry and thermal properties of the nozzles and thermal properties of the ink. A constant ink pressure can be achieved by applying pressure to the ink reservoir 40 under the control of an ink pressure regulator 46. Alternatively, the ink reservoir 40 can be left unpressurized, or even under a reduced pressure (vacuum), and a pump can be employed to deliver ink from the ink reservoir under pressure to the printhead 30. In such an embodiment, the ink pressure regulator 46 can include an ink pump control system. The ink is distributed to the printhead 30 through an ink channel 47. The ink preferably flows through slots or holes etched through a silicon substrate of printhead 30 to its front surface, where a plurality of nozzles and drop forming transducers, for example, heaters, are situated. When printhead 30 is fabricated from silicon, the drop forming transducer control circuits 26 can be integrated with the printhead 30. The printhead 30 also includes a deflection mechanism 70 which is described in more detail below with reference to FIGS. 2 and 3.

Referring to FIG. 2, a schematic view of a continuous liquid printhead 30 is shown. A jetting module 48 of printhead 30 includes an array of nozzles 50 formed in a nozzle plate 49. In FIG. 2, nozzle plate 49 is affixed to the jetting module 48. Alternatively, the nozzle plate 49 can be integrally formed with the jetting module 48. Liquid, for example, ink, is supplied to the nozzles 50 via ink channel 47 at a pressure sufficient to form continuous liquid streams 52 (sometimes referred to as filaments) from each nozzle 50. In FIG. 2, the array of nozzles 50 extends into and out of the figure.

Jetting module 48 is operable to cause liquid drops 54 to break off from the liquid stream 52 in response to image data. To accomplish this, jetting module 48 includes a drop stimulation or drop forming transducer 28 (e.g., a heater, a piezoelectric actuator, or an electrohydrodynamic stimulation electrode), that, when selectively activated, perturbs the liquid stream 52, to induce portions of each filament to break off and coalesce to form the drops 54. Depending on the type of transducer used, the transducer can be located in or adjacent to the liquid chamber that supplies the liquid to the nozzles 50 to act on the liquid in the liquid chamber, can be located in or immediately around the nozzles 50 to act on the liquid as it passes through the nozzle, or can be located adjacent to the liquid stream 52 to act on the liquid stream 50 after it has passed through the nozzle 50.

In FIG. 2, drop forming transducer 28 is a heater 51, for example, an asymmetric heater or a ring heater (either segmented or not segmented), located in the nozzle plate 49 on one or both sides of the nozzle 50. This type of drop formation is known and has been described in, for example, U.S. Pat. No. 6,457,807 (Hawkins et al.); U.S. Pat. No. 6,491,362 (Jeanmaire); U.S. Pat. No. 6,505,921 (Chwalek et al.); U.S. Pat. No. 6,554,410 (Jeanmaire et al.); U.S. Pat. No. 6,575,566 (Jeanmaire et al.); U.S. Pat. No. 6,588,888 (Jeanmaire et al.); U.S. Pat. No. 6,793,328 (Jeanmaire); U.S. Pat. No. 6,827,429 (Jeanmaire et al.); and U.S. Pat. No. 6,851,796 (Jeanmaire et al.), each of which is incorporated herein by reference.

Typically, one drop forming transducer 28 is associated with each nozzle 50 of the nozzle array. However, in some configurations, a drop forming transducer 28 can be associated with groups of nozzles 50 or all of the nozzles 50 in the nozzle array.

Referring to FIG. 2 the printing system has associated with it, a printhead 30 that is operable to produce, from an array of nozzles 50, an array of liquid streams 52. A drop forming device is associated with each liquid stream 52. The drop formation device includes a drop forming transducer 28 and a drop formation waveform source 55 that supplies a drop formation waveform 60 to the drop forming transducer 28. The drop formation waveform source 55 is a portion of the mechanism control circuits 26 (FIG. 1). In some embodiments in which the nozzle plate is fabricated of silicon, the drop formation waveform source 55 is formed at least partially on the nozzle plate 49. The drop formation waveform source 55 supplies a drop formation waveform 60, which typically includes a sequence of pulses having a fundamental frequency f_{O} and a fundamental period of T_{O}=1/f_{O}, to the drop formation transducer 28, which produces a modulation in the liquid jet with a wavelength λ. The modulation grows in amplitude to cause portions of the liquid stream 52 to break off into drops 54. Through the action of the drop formation device, a sequence of drops 54 is produced. In accordance with the drop formation waveform 60, the drops 54 are formed at the fundamental frequency f_{O} with a fundamental period of T_{O}=1/f_{O}. In FIG. 2, liquid stream 52 breaks off into drops with a regular period at breakoff location 59, which is a distance, called the break off length, BL from the nozzle 50. The distance between a pair of successive drops 54 is essentially equal to the wavelength λ of the perturbation on the liquid stream 52. The stream of drops 54 formed from the liquid stream 52 follow an initial trajectory 57.

The break off time of the droplet for a particular printhead can be altered by changing at least one of the amplitude, duty cycle, or number of the stimulation pulses to the respective resistive elements surrounding a respective resistive nozzle orifice. In this way, small variations of either pulse duty cycle or amplitude allow the droplet break off times to be modulated in a predictable fashion within ±one-tenth the droplet generation period.

Also shown in FIG. 2 is a charging device 61 comprising charging electrode 62 and charging electrode waveform source 63. The charging electrode 62 associated with the liquid jet is positioned adjacent to the break off point 59 of the liquid stream 52. If a voltage is applied to the charging electrode 62, electric fields are produced between the charging electrode 62 and the electrically grounded liquid jet, and the capacitive coupling between the two produces a net charge on the end of the electrically conductive liquid stream 52. (The liquid stream 52 is grounded by means of contact with the liquid chamber of the grounded drop generator.) If the end portion of the liquid jet breaks off to form a drop while there is a net charge on the end of the liquid stream 52, the charge of that end portion of the liquid stream 52 is trapped on the newly formed drop 54.

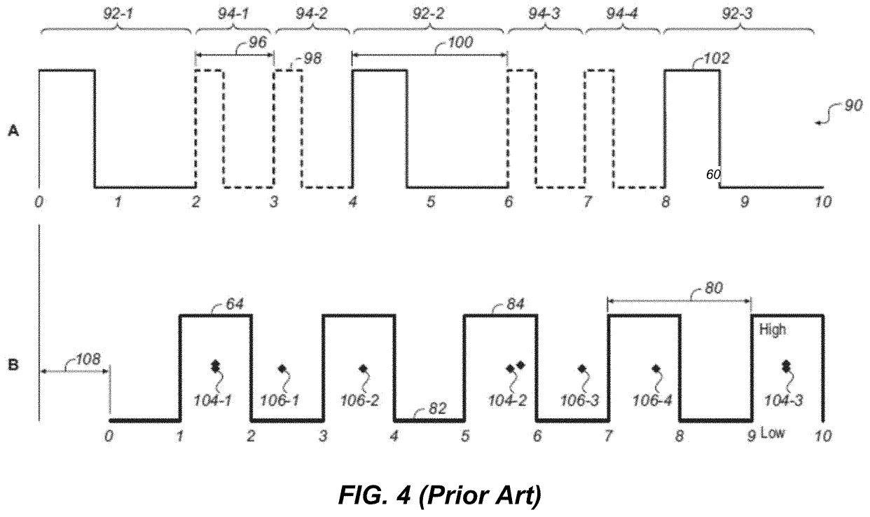

The voltage on the charging electrode 62 is controlled by the charging electrode waveform source 63, which provides a charging electrode waveform 64 operating at a charging electrode waveform period 80 (shown in FIG. 4). The charging electrode waveform source 63 provides a varying electrical potential between the charging electrode 62 and the liquid stream 52. The charging electrode waveform source 63 generates a charging electrode waveform 64, which includes a first voltage state and a second voltage state; the first voltage state being distinct from the second voltage state. An example of a charging electrode waveform is shown in part B of FIG. 4. The two voltages are selected such that the drops 54 breaking off during the first voltage state acquire a first charge state and the drops 54 breaking off during the second voltage state acquire a second charge state. The charging electrode waveform 64 supplied to the charging electrode 62 is independent of, or not responsive to, the image data to be printed. The charging device 61 is synchronized with the drop formation device using a conventional synchronization device 27, which is a portion of the control circuits 26, (see FIG. 1) so that a fixed phase relationship is maintained between the charging electrode waveform 64 produced by the charging electrode waveform source 63 and the clock of the drop formation waveform source 55. As a result, the phase of the break off of drops 54 from the liquid stream 52, produced by the drop formation waveforms 92-1, 92-2, 92-3, 94-1, 94-2, 94-3, 94-4 (see FIG. 4), is phase locked to the charging electrode waveform 64. As indicated in FIG. 4, there can be a phase shift 108, between the charging electrode waveform 64 and the drop formation waveforms 92-1, 92-2, 92-3, 94-1, 94-2, 94-3, 94-4.

With reference now to FIG. 3, printhead 30 includes a drop forming transducer 28 which creates a liquid stream 52 that breaks up into ink drops 54. Selection of drops 54 as printing drops 66 or non-printing drops 68 will depend upon the phase of the droplet break off relative to the charging electrode voltage pulses that are applied to the to the charging electrode 62 that is part of the deflection mechanism 70, as will be described below. The charging electrode 62 is variably biased by a charging electrode waveform source 63. The charging electrode waveform source 63 provides a charging electrode waveform 64, in the form of a sequence of charging pulses. The charging electrode waveform 64 is periodic, having a charging electrode waveform period 80 (FIG. 4).

An embodiment of a charging electrode waveform 64 is shown in part B of FIG. 4. The charging electrode waveform 64 comprises a first voltage state 82 and a second voltage state 84. Drops breaking off during the first voltage state 82 are charged to a first charge state and drops breaking off during the second voltage state 84 are charged to a second charge state. The second voltage state 84 is typically at a high level, biased sufficiently to charge the drops 54 as they break off. The first voltage state 82 is typically at a low level relative to the printhead 30 such that the first charge state is relatively uncharged when compared to the second charge state. An exemplary range of values of the electrical potential difference between the first voltage state 82 and a second voltage state 84 is 50 to 300 volts and more preferably 90 to 150 volts.

Returning to a discussion of FIG. 3, when a relatively high level voltage or electrical potential is applied to the charging electrode 62 and a drop 54 breaks off from the liquid stream 52 in front of the charging electrode 62, the drop 54 acquires a charge and is deflected by deflection mechanism 70 towards the ink catcher 72 as non-printing drop 68. The non-printing drops 68 that strike the catcher face 74 form an ink film 76 on the face of the ink catcher 72. The ink film 76 flows down the catcher face 74 and enters liquid channel 78 (also called an ink channel), through which it flows to the ink recycling unit 44. The liquid channel 78 is typically formed between the body of the ink catcher 72 and a lower plate 79.

Deflection occurs when drops 54 break off from the liquid stream 52 while the potential of the charging electrode 62 is provided with an appropriate voltage. The drops 54 will then acquire an induced electrical charge that remains upon the droplet surface. The charge on an individual drop 54 has a polarity opposite that of the charging electrode 62 and a magnitude that is dependent upon the magnitude of the voltage and the coupling capacitance between the charging electrode 62 and the drop 54 at the instant the drop 54 separates from the liquid jet. This coupling capacitance is dependent in part on the spacing between the charging electrode 62 and the drop 54 as it is breaking off. It can also be dependent on the vertical position of the breakoff point 59 relative to the center of the charge electrode 62. After the charged drops 54 have broken away from the liquid stream 52, they continue to pass through the electric fields produced by the charge plate. These electric fields provide a force on the charged drops deflecting them toward the charging electrode 62. The charging electrode 62, even though it cycled between the first and the second voltage states, thus acts as a deflection electrode to help deflect charged drops away from the initial trajectory 57 and toward the ink catcher 72. After passing the charging electrode 62, the drops 54 will travel in close proximity to the catcher face 74 which is typically constructed of a conductor or dielectric. The charges on the surface of the non-printing drops 68 will induce either a surface charge density charge (for a catcher face 74 constructed of a conductor) or a polarization density charge (for a catcher face 74 constructed of a dielectric). The induced charges on the catcher face 74 produce an attractive force on the charged non-printing drops 68. The attractive force on the non-printing drops 68 is identical to that which would be produced by a fictitious charge (opposite in polarity and equal in magnitude) located inside the ink catcher 72 at a distance from the surface equal to the distance between the ink catcher 72 and the non-printing drops 68. The fictitious charge is called an image charge. The attractive force exerted on the charged non-printing drops 68 by the catcher face 74 causes the charged non-printing drops 68 to deflect away from their initial trajectory 57 and accelerate along a non-print trajectory 86 toward the catcher face 74 at a rate proportional to the square of the droplet charge and inversely proportional to the droplet mass. In this embodiment, the ink catcher 72, due to the induced charge distribution, comprises a portion of the deflection mechanism 70. In other embodiments, the deflection mechanism 70 can include one or more additional electrodes to generate an electric field through which the charged droplets pass so as to deflect the charged droplets. For example, an optional single biased deflection electrode 71 in front of the upper grounded portion of the catcher can be used. In some embodiments, the charging electrode 62 can include a second portion on the second side of the jet array, denoted by the dashed line charging electrode 62′, which supplied with the same charging electrode waveform 64 as the first portion of the charging electrode 62.

In the alternative, when the drop formation waveform 60 applied to the drop forming transducer 28 causes a drop 54 to break off from the liquid stream 52 when the electrical potential of the charging electrode 62 is at the first voltage state 82 (FIG. 4) (i.e., at a relatively low potential or at a zero potential), the drop 54 does not acquire a charge. Such uncharged drops are unaffected during their flight by electric fields that deflect the charged drops. The uncharged drops therefore becomes printing drops 66, which travel in a generally undeflected path along the trajectory 57 and impact the print medium 32 to form a print dots 88 on the print medium 32, as the recoding medium is moved past the printhead 30 at a speed Vₘ. The charging electrode 62, deflection electrode 71 and ink catcher 72 serve as a drop selection system 69 for the printhead 30. FIG. 4 illustrates how selected drops can be printed by the control of the drop formation waveforms supplied to the drop forming transducer 28. Section A of FIG. 4 shows a drop formation waveform 60 formed as a sequence that includes three drop formation waveform 92-1, 92-2, 92-3, and four drop formation waveforms 94-1, 94-2, 94-3, 94-4. The drop formation waveforms 94-1, 94-2, 94-3, 94-4 each have a period 96 and include a pulse 98, and each of the drop formation waveforms 92-1, 92-2, 92-3 have a longer period 100 and include a longer pulse 102. In this example, the period 96 of the drop formation waveforms 94-1, 94-2, 94-3, 94-4 is the fundamental period T_{O}, and the period 100 of the drop formation waveforms 92-1, 92-2, 92-3 is twice the fundamental period, 2T_{O}. The drop formation waveforms 94-1, 94-2, 94-3, 94-4 each cause individual drops to break off from the liquid stream. The drop formation waveforms 92-1, 92-2, 92-3, due to their longer period, each cause a larger drop to be formed from the liquid stream. The larger drops 54 formed by the drop formation waveforms 92-1, 92-2, 92-3 each have a volume that is approximately equal to twice the volume of the drops 54 formed by the drop formation waveforms 94-1, 94-2, 94-3, 94-4.

As previously mentioned, the charge induced on a drop 54 depends on the voltage state of the charging electrode at the instant of drop breakoff. The B section of FIG. 4 shows the charging electrode waveform 64 and the times, denoted by the diamonds, at which the drops 54 break off from the liquid stream 52. The waveforms 92-1, 92-2, 92-3 cause large drops 104-1, 104-2, 104-3 to break off from the liquid stream 52 while the charging electrode waveform 64 is in the second voltage state 84. Due to the high voltage applied to the charging electrode 62 in the second voltage state 84, the large drops 104-1, 104-2, 104-3 are charged to a level that causes them to be deflected as non-printing drops 68 such that they strike the catcher face 74 of the ink catcher 72 in FIG. 3. These large drops may be formed as a single drop (denoted by the double diamond for 104-1), as two drops that break off from the liquid stream 52 at almost the same time that subsequently merge to form a large drop (denoted by two closely spaced diamonds for 104-2), or as a large drop that breaks off from the liquid stream that breaks apart and then merges back to a large drop (denoted by the double diamond for 104-3). The waveforms 94-1, 94-2, 94-3, 94-4 cause small drops 106-1, 106-2, 106-3, 106-4 to form. Small drops 106-1 and 106-3 break off during the first voltage state 82, and therefore will be relatively uncharged; they are not deflected into the ink catcher 72, but rather pass by the ink catcher 72 as printing drops 66 and strike the print media 32 (see FIG. 3). Small drops 106-2 and 104-4 break off during the second voltage state 84 and are deflected to strike the ink catcher 74 as non-printing drops 68. The charging electrode waveform 64 is not controlled by the pixel data to be printed, while the drop formation waveform 60 is determined by the print data. This type of drop deflection is known and has been described in, for example, U.S. Pat. No. 8,585,189 (Marcus et al.); U.S. Pat. No. 8,651,632 (Marcus); U.S. Pat. No. 8,651,633 (Marcus et al.); U.S. Pat. No. 8,696,094 (Marcus et al.); and U.S. Pat. No. 8,888,256 (Marcus et al.), each of which is incorporated herein by reference.

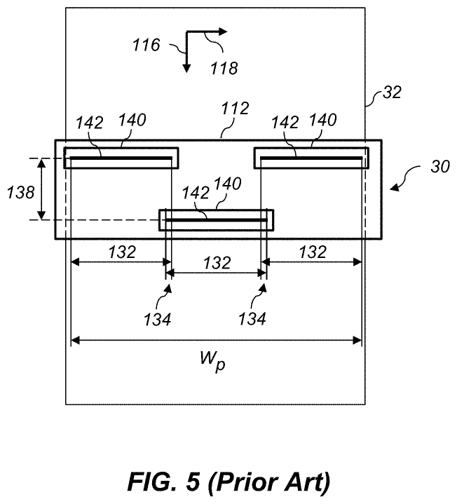

In some ink jet printing systems, the printhead 30 can include a plurality of individual jetting modules 140 that are stitched together to provide a wider cross-track printhead width Wₚ as illustrated in FIG. 5. The illustrated printhead 30 includes a printhead assembly 112 with three jetting modules 140 arranged across a width dimension of the print medium 32 in a staggered array configuration. The width dimension of the print medium 32 is the dimension in cross-track direction 118, which is perpendicular to in-track direction 116 (i.e., the motion direction of the print medium 32). Such printhead assemblies 112 are sometimes referred to as “lineheads.”

Each of the jetting modules 140 includes a plurality of inkjet nozzles arranged in nozzle array 142 and is adapted to print a swath of image data in a corresponding printing region 132. Commonly, the jetting modules 140 are arranged in a spatially-overlapping arrangement where the printing regions 132 overlap in overlap regions 134. In the overlap regions 134, nozzles from more than one nozzle array 142 can be used to print the image data. The nozzle arrays 142 for the set of jetting modules 140 can collectively be referred to as a “staggered array of ink nozzles” for the printhead 30, or more generally as simply an “array of ink nozzles.”

Stitching is a process that refers to the alignment of the printed images produced from jetting modules 140 for the purpose of creating the appearance of a single page-width line head. In the exemplary arrangement shown in FIG. 5, three jetting modules 140 are stitched together at overlap regions 134 to form a page-width printhead assembly 112. The page-width image data is processed and segmented into separate portions that are sent to each jetting module 140 with appropriate time delays to account for the nozzle array spacing 138 associated with the staggered positions of the jetting modules 140. The image data portions printed by each of the jetting modules 140 is sometimes referred to as “swaths.” Stitching systems and algorithms are used to determine which nozzles of each nozzle array 142 should be used for printing in the overlap region 134. Preferably, the stitching algorithms create a boundary between the printing regions 132 that is not readily detected by eye. Exemplary stitching algorithms are described in commonly-assigned U.S. Pat. Nos. 7,871,145 and 9,908,324, each of which is incorporated herein by reference.

In some applications, the image data being printed by the printhead 30 may have a cross-track width which is substantially smaller than the printhead width Wₚ of the printhead 30. For example, the printer system 20 (FIG. 1) may include a printhead 30 having a single printing module 140 with a 4 inch printing width, and may be used to print image content such as barcodes or address labels which have cross-track width of 1 inch or less. Over time, printing defects may be observed corresponding to particular cross-track positions on the printhead 30 (e.g., due to clogged or misdirected ink nozzles 50). In conventional printer systems 20, when the printing defects reach some threshold level of objectionability, it is necessary to remove the printhead 30 from the printer system 20 for servicing or replacement. This can result in significant costs and delays which can impact productivity and profitability.

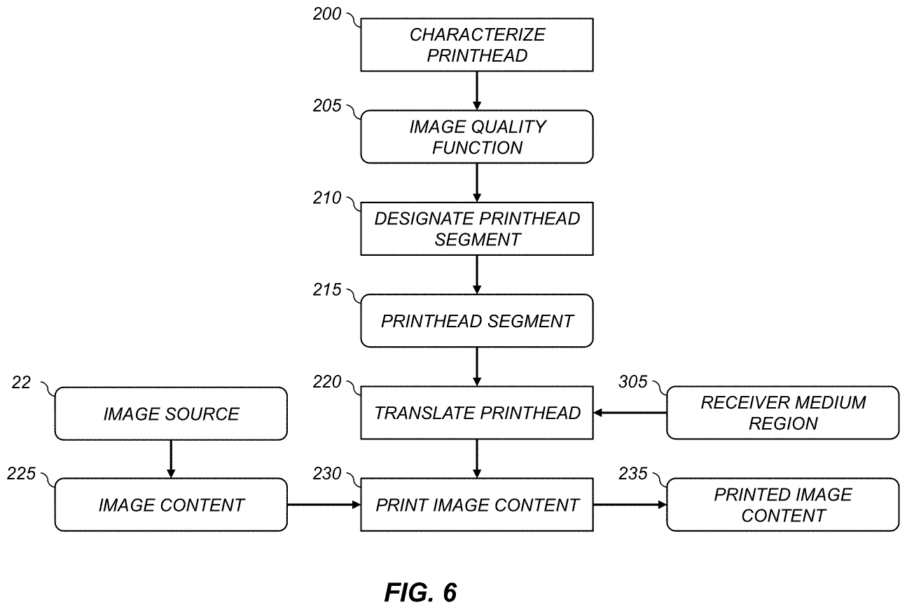

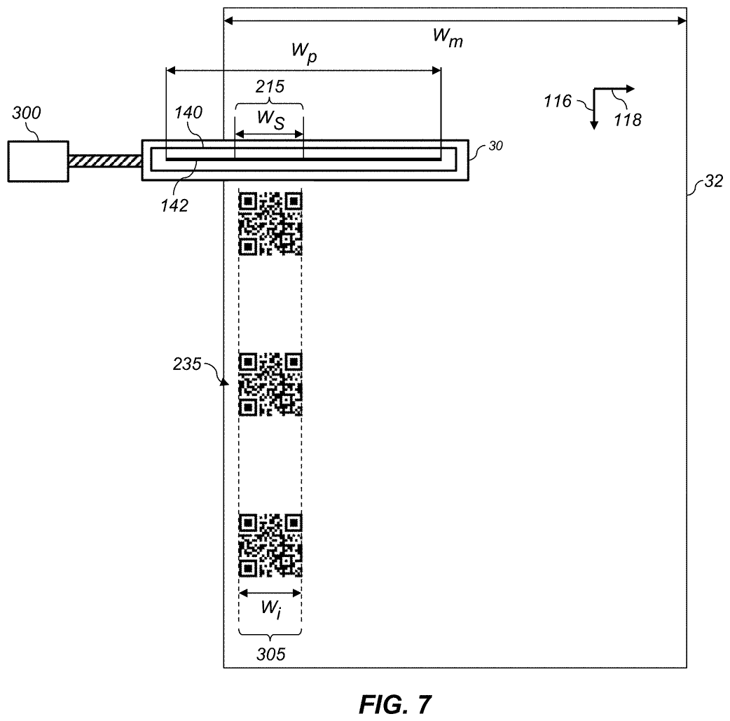

The present invention will now be described with reference to FIG. 6 which illustrates a flowchart of a method for printing image content 225 on an inkjet printer system 20 (FIG. 1). The image content 225 is received from an image source 22. The image content 225 has a cross-track image width Wᵢ that is narrower than the printhead width Wₚ of the printhead 30 as illustrated in FIG. 7. The image content 225 is to be printed onto a receiver medium 32 having a media width Wₘ using a printhead 30 having a printhead width Wₚ. In a preferred embodiment, the receiver medium 32 is a web of media which is moved past the printhead 30 in the in-track direction 116 using a web transport system. In other embodiments, the receiver medium 32 can be a sheet medium which is moved relative to the printhead 32 using a sheet transport system. The present invention will be most valuable for cases when the printhead width Wₚ exceeds the image width Wᵢ by a factor of at least 2×, although there can be some benefit even if exceeds the image width Wᵢ by less than 2×. In the example of FIG. 7, the printhead width Wₚ exceeds the image width Wᵢ by a factor of about 4×.

Returning to a discussion of FIG. 6, a characterize printhead step 200 is used to determine an image quality function 205 for the printhead 30 (FIG. 7) representing an image quality level as a function of cross-track position. In some embodiments, the image quality function 205 may be determined by assessing the image quality level at a set of predefined cross-track positions using an appropriate image quality metric. In some cases, the image quality metric can be a continuous parameter that can take on a range of image quality values. In other cases, the image quality metric can be a binary value which indicates whether the image quality is acceptable or unacceptable at a particular cross-track position. In other embodiments, the printhead 30 can be divided into a plurality of printhead segments, and the image quality function 205 can be a representation of an overall image quality level determined for each printhead segment. Additional details of the characterize printhead step 200 according to several exemplary embodiments will be discussed later.

A designate printhead segment step 210 is used to designate a segment of the printhead 30 wherein the image quality level within the designated printhead segment 215 is acceptable. The printhead segment 215 has a cross-track segment width Wₛ which is at least as large as the cross-track image width Wᵢ as illustrated in FIG. 7 such that the image content 225 can be printed by the printhead segment 215.

A translate printhead step 220 is used to translate the printhead 30 relative to a receiver medium 32 in the cross-track direction such that the designated printhead segment 215 of the printhead 30 is aligned with a receiver medium region 305 on the receiver medium 32 where the image content 225 is to be printed as illustrated in FIG. 7. In an exemplary embodiment, the translate printhead step 220 translates the printhead 30 using an appropriate translation mechanism 300 while the receiver medium 32 remains at a fixed cross-track position. In other embodiments, the translate printhead step can use the translation mechanism 300 to translate the receiver medium 32 while the printhead 30 remains at a fixed cross-track position. Any appropriate type of translation mechanism 300 known in the art can be used in accordance with the present invention. For example, in a preferred embodiment the translation mechanism 300 can be a leadscrew mechanism which is used to translate the printhead 30 in the cross-track direction. Other types of translation mechanisms would include rack-and-pinion mechanism or a cable-and-pulley mechanism. Many types of translation mechanisms 300 are known in the art, and these examples should not be considered to be exhaustive. In some embodiments, the translation mechanism 300 can be automatically controlled, for example using a computer-controlled stepper motor. In other embodiments, the translation mechanism 300 can be manually controlled by a user, for example using a knob which is rotated by hand.

Once the printhead 30 has been positioned such that the designated printhead segment 215 is aligned with the receiver medium region 305 where the image content 225 is to be printed, a print image content step 230 is used to print the image content 225 to produce printed image content 235 on the receiver medium 32. An offset can be used to shift the image content 225 in the cross-track direction relative to the nozzle array 142 such that the nozzles in the printhead segment 215 that are aligned with the receiver medium region 305 are used to print the printed image content 235. In the example of FIG. 7, the printed image content 235 is a bar code. In this case, the bar code is a well-known type of 2-D bar code know a QR code. The bar code can be used to store information such as an order number, a product number, or a website address. For example, the bar codes can be printed on labels to be affixed to an item (e.g., a product or product packaging) to enable tracking the item through a manufacturing or shipping process. Other types of bar codes can also be printed such as the well-known UPC codes. The printed image content 235 can also include other types of image content that have a limited cross-track spatial extent such as text (e.g., serial numbers or mailing addresses) or graphics (e.g., regions of a spot color or a highlight color). The present invention will be most valuable when the image width Wᵢ of the printed image content 235 is significantly narrower than the printhead width Wp of the printhead 30 such that only a fraction of the nozzles in the nozzle array 142 are needed to produce the printed image content 235.

The system configuration process of FIG. 6 can be repeated at different times such that different printhead segments 215 can be used to print the image content 225. For example, if it is observed by a human operator that the image quality of the printed image content 235 has degraded to an unacceptable level (e.g., due to a clogged inkjet nozzle), then the system configuration process can be repeated such that a different printhead segment 215 is designated which will provide an acceptable image quality. Similarly, an automatic image quality evaluation process can be used to assess the image quality of the printed image 235 by capturing a digital image and automatically analyzing the captured digital image to determine when the image quality falls to an unacceptable level. In some embodiments, the system configuration process can be performed at predefined time intervals (e.g., once per day) to ensure that the inkjet printer system is delivering printed image content 235 having an acceptable level of image quality.

The method of the present invention has the advantage that the life of the printhead 30 can be extended before it is necessary to service or replace the printhead by translating the printhead 30 to use a different printhead segment 215. It has the additional advantage that it can enable a higher yield in the printhead manufacturing process since the printhead 30 can be positioned to avoid using printhead segments that have an unacceptable image quality level, thereby rendering a printhead that may have needed to be discarded to be usable.

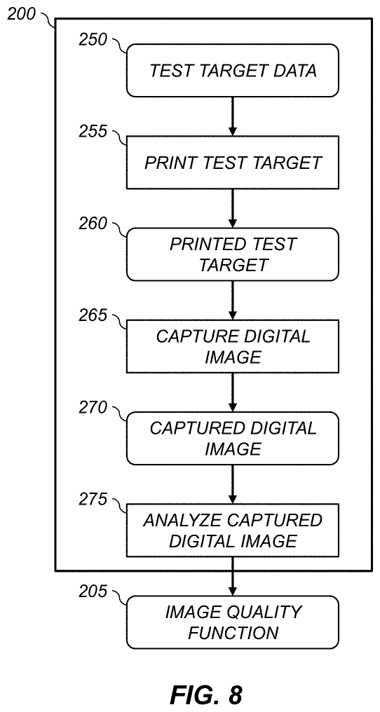

FIG. 8 is a flowchart illustrating additional details of the characterize printhead step 200 of FIG. 6 according to one exemplary embodiment. A print test target step 255 is used to print test target data 250 to produce a printed test target 260. The test target data 250 includes one or more test patterns that can be used to assess the image quality as a function of cross-track position. The test patterns can be designed to be assessed automatically (e.g., by scanning and analyzing the printed test target 260) and/or to be assessed visually by a human observer.

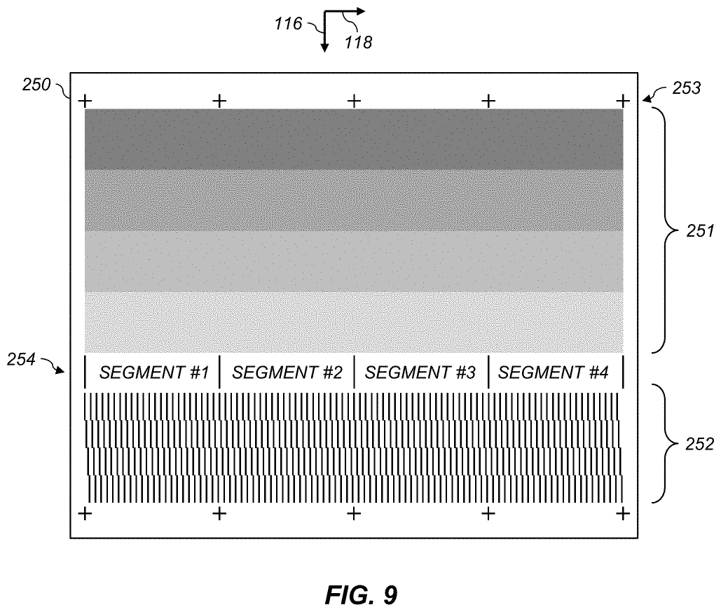

FIG. 9 illustrates some exemplary test patterns that can be used to assess the image quality as a function of cross-track position. The exemplary test target data 250 includes a flatfield test pattern 251 having several flat field patches which span the width of the printhead 30 (FIG. 7) in the cross-track direction 118. The test target data 250 also includes a single pixel wide line test pattern 252. The single pixel wide line test pattern 252 has a single pixel wide line extending in the in-track direction 118 corresponding to each nozzle in the printhead 30. The test target data 250 also includes alignment marks 253 which can be useful for the automatic assessment of the printed test target 260, as well as segment labels 254 which can be useful for visual assessment by a human observer.

Returning to a discussion of FIG. 8, a capture digital image step 265 is used to capture an image of the printed test target 260 using a digital image capture device to provide a captured digital image 270. The digital image capture device can be any appropriate device such as a digital camera, an image scanner or a bar-code scanner. The captured digital image 270 can be a 2-D digital image, or in some cases can be a 1-D digital image. In some embodiments the capture digital image step 265 is performed by manually taking the printed test target 260 and scanning it using an appropriate image scanning system such as a flatbed scanner. In other embodiments, the printer system 20 (FIG. 1) may incorporate a digital imaging system (e.g., a digital camera) which can be used to automatically capture an image of the printed test target 260 as the receiver media travels through printer. Preferably, the spatial resolution of captured image should be at least as large as the spatial resolution of the printhead 30 so that there is at least one image pixel per inkjet nozzle in order to be able to detect various artifacts.

An analyze captured digital image step 275 is then used to automatically analyze the captured digital image 270 to determine an assessment of the image quality function 205 giving the image quality level as a function of cross-track position. The analyze captured digital image step 275 can use any analysis process known in the art to assess the image quality of the printed test target 260. The particular analysis process that is used will generally be a function of the test pattern(s) included in the test target data 250. For example, if the printhead 30 is performing well, the flatfield test pattern 251 of FIG. 9 should be uniform across the width of the printed test target. A variety of artifacts can occur in inkjet printing systems which will show up as non-uniformities in the printed test target 260. For example, clogged or misdirected nozzles can result in artifacts such as vertical lines or streaks in the printed test target 260. To automatically detect such artifacts a number of lines in the captured digital image 270 can be averaged together to determine a line profile L(x). Local variations in the line profile will be an indication of artifacts. The magnitude of the variations can be used as a measure of image quality level, where larger variations will correspond to lower image quality. One such measure of image quality Q is given by:

Q=100−k|L(x)−S(x)| (1)

where, S(x) is a smoothed version of the line profile, and k is an empirically-determined scale value which is used to relate the size of the local variations to the perceived impact on image quality. This image quality measure looks for deviations of the line profile from the expected flat profile. In some embodiments, the smoothed line profile can be determined by convolving the line profile with a low-pass filter F(x): S(x)=L(x)*F(x). In other embodiments, the smoothed line profile S(x) can be determined by fitting a smooth function such as a line, a polynomial or a smoothing spline to the line profile.

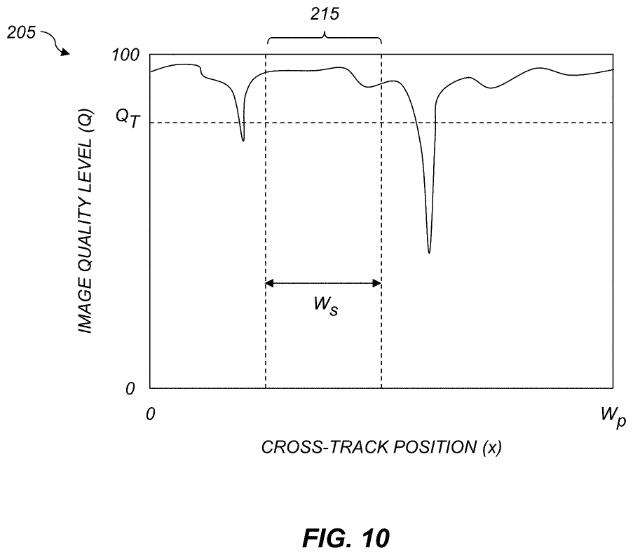

FIG. 10 illustrates an exemplary image quality function 205 showing a computed image quality level Q as a function of cross-track position x. It can be seen that there are two cross-track positions where there is a significant dip in the image quality due to the presence of local variations (e.g., streaks) in the flatfield test pattern 251 of a printed test target 260. In some applications, a threshold image quality level Q_{T} can be defined where image quality levels below the threshold image quality level are deemed to be unacceptable and those above the threshold image quality level are deemed to be acceptable. If a dip in the image quality function 205 which falls below the threshold image quality level were to occur within the printhead segment 215 being used, then the image quality for that printhead segment 215 can be deemed to be unacceptable. However, in this case it can be seen that there are segments of the printhead having a segment width of Wₛ where the image quality level exceeds the threshold image quality level. In some embodiments, the designate printhead segment step 210 (FIG. 6) can identify a printhead segment 215 that satisfies this criterion.

In some embodiments, a set of printhead segments can be predefined, where each of the predefined printhead segments has a different cross-track position. For example, the printhead 30 can be divided into a plurality of non-overlapping equal width segments (for example corresponding to the image regions of the test target data 250 of FIG. 9 which are labeled with different segment labels 254). In this case, the designate printhead segment step 210 (FIG. 6) can evaluate the image quality function 205 to identify one of the predefined printhead segments that has an acceptable image quality level or a highest image quality level to be the designated printhead segment 215. In other embodiments, the designated printhead segment 215 can be determined by sliding a window having a width equal the segment width Wₛ across the image quality function 205 to determine an overall image quality level corresponding to each possible segment position. The segment position having the highest overall image quality level can then be selected, or alternately the first segment position having an acceptable image quality level can be selected.

Similarly, the single-pixel-wide line test pattern 252 (FIG. 9) can also be analyzed to provide a measure of the image quality level. For example, a clogged nozzle will show up as a missing line in the printed test target 260, and a misdirected nozzle will cause a position of the printed line to be shifted relative to an expected position, which show up as unequal spacings between the printed lines. In some cases a nozzle may behave erratically which would result in a jagged line. For example, jagged lines sometimes result when an ink filter gets dirty. These artifacts can easily be detected and characterized with well-known image analysis techniques, and can be used to provide an estimated image quality level. For example, an image quality loss can be defined which is a function of the number of clogged nozzles in a printhead segment and the magnitude of the nozzle misdirection and/or the line raggedness:

Q=100−k_{c}N_{c}−kₘ(Σ_{i=1,M}^{Δx}^{ᵢ}) (2)

where N_{c} is the number of clogged pixels in the printhead segment, Δxᵢ is the average cross-track misplacement of the line printed by the i^{th} nozzle (which will characterize both misdirection and raggedness), M is the number of nozzles in the printhead segment, and k_{c} and kₘ are empirically-determined scale values which is used to relate the size of the local variations to the perceived impact on image quality. In other embodiments, a simple binary quality measure can be defined where the detection of one or more clogged nozzles within a printhead segment sets the image quality level to “unacceptable.”

In some embodiments, the test target data 250 (FIG. 8) can include content similar to the image content 225 (FIG. 6) that is intended to be printed by the printer system. For example, the test target data 250 can include barcode patterns at cross-track positions corresponding to a set of predefined printhead segment positions. In this case, the capture digital image step 265 (FIG. 8) can include directing a barcode scanner to read the printed barcode pattern, and the analyze captured digital image step 275 (FIG. 8) can include verifying that the barcode pattern can be accurately read to extract the encoded information.

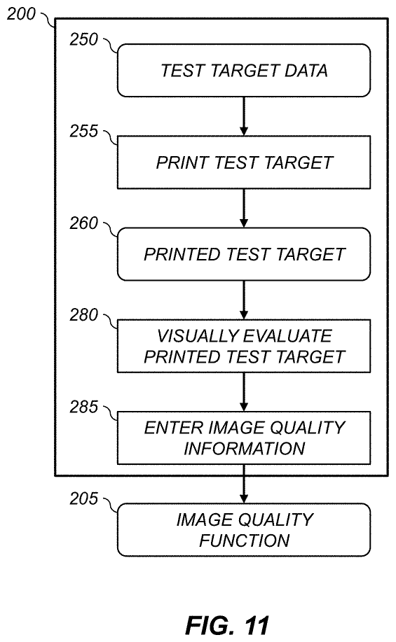

FIG. 11 is a flowchart illustrating additional details of the characterize printhead step 200 of FIG. 6 according to an alternate embodiment where the image quality function 205 is determined by visual evaluation of the printed test target 260. In this case, the test target data 250 can be the same as that which would be appropriate for the automatic analysis method of FIG. 8, or it can include features which are specially designed for visual evaluation. For example, the test target data 250 of FIG. 9 can be used for either automatic evaluation or visual evaluation, but it does include features (e.g., the segment labels 254) which are particularly relevant to visual evaluation.

In the method of FIG. 11, a visually evaluate printed test target step 280 is performed by instructing a user to visually evaluate the printed test target to assess image quality level as a function of cross-track position. An enter image quality information step 285 is then performed by the user wherein information providing an indication the assessed image quality level as a function of cross-track position is entered into an appropriate user interface.

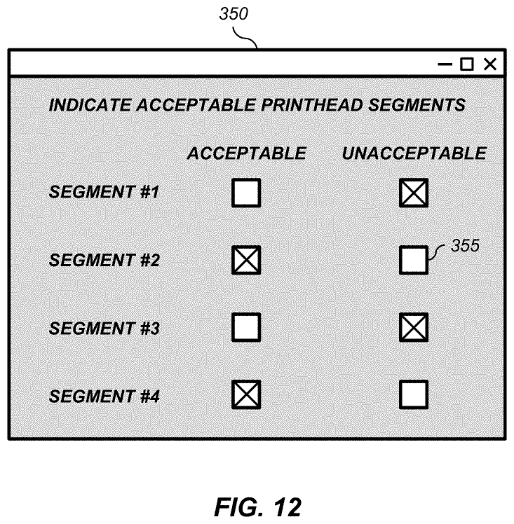

FIG. 12 shows an example of a user interface 350 that can be used to perform the enter image quality information step 285. In this case, the user performs the visually evaluate printed test target step 280 by visually evaluating the printed test target 260 corresponding to test target data 250 such as that illustrated in FIG. 9. The user can visually evaluate whether the flatfield test pattern 251 includes unacceptable non-uniformity artifacts in the image regions corresponding to each of the different printhead segments. The user can also visually evaluate the lines in the single pixel wide line test pattern 252 to look for artifacts associated with clogged or misdirected nozzles in the image regions corresponding to each of the different printhead segments. The user can then subjectively determine whether the image quality in the image regions corresponding to each of the different printhead segments is acceptable or unacceptable. The user can then perform the enter image quality information step 285 by clicking on the appropriate check box 355 for each printhead segment indicating whether or not the image quality is “acceptable” or “unacceptable.”

In a variation of this embodiment, the user interface 350 can simply enable the user to enter information (e.g., a printhead segment number) providing an indication of one of the printhead segments which is visually identified as having an acceptable image quality level. The designate printhead segment step 210 (FIG. 6) would then designate this printhead segment 215 for use.

In another variation of this embodiment, the user can visually evaluate the image quality as a function of cross-track position at a finer granularity than the printhead segment level. For example, a numerical scale can be provided across the width of the test target data indicating the cross-track position, wherein the numerical scale can include a plurality of cross-track positions within each printhead segment. The user can then be instructed to enter an indication of the image quality level at each cross-track position. For example, the user could indicate any cross-track positions having an unacceptable image quality level. Alternatively, the user could classify the image quality level at each cross-track position using a series of subject categories (e.g., “excellent,” “good,” “fair,” or “unacceptable”). The designate printhead segment step 210 (FIG. 6) could then identify a printhead segment having the highest average subjective rating across the set of corresponding cross-track positions with no “unacceptable” ratings.

In another variation, rather than directly entering image quality information about each cross-track position into the user interface, the user can simply identify the printhead segment having the highest image quality. This effectively combines the characterize printhead step 200 and the designate printhead segment step 210 into a single step.

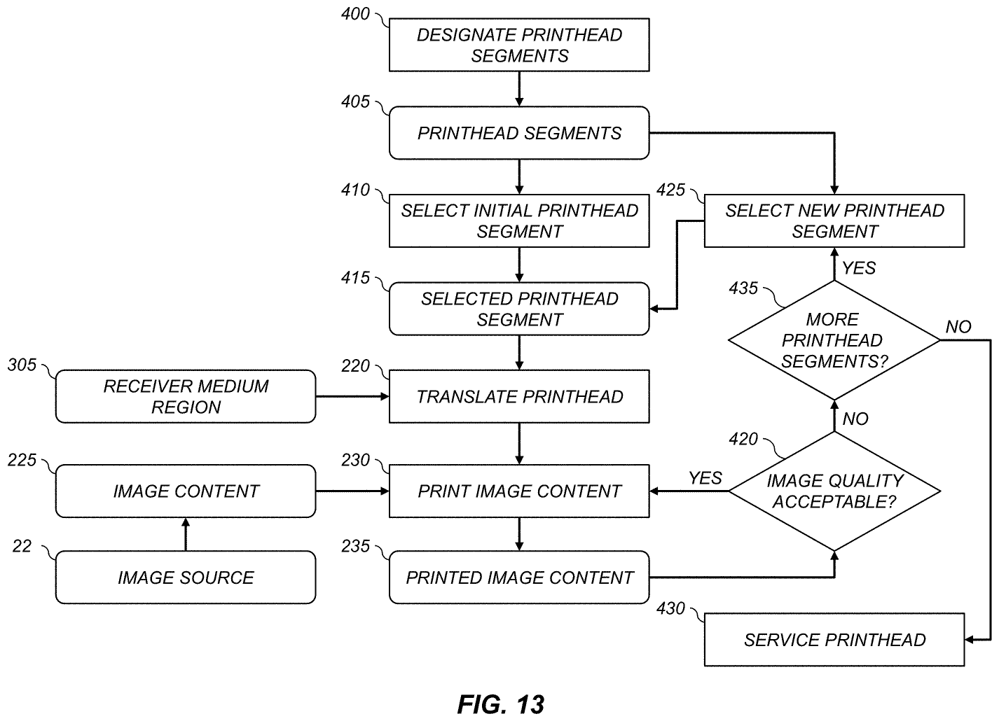

In the preceding examples, the image quality level is assessed as a function of cross-track position and a printhead segment 215 is designated responsive to the image quality function 205 that has acceptable image quality. FIG. 13 illustrates an alternate embodiment wherein a designate printhead segments step 400 is used to designate a sequence of printhead segments 405. A select initial printhead segment step 410 is used to select an initial printhead segment (e.g., printhead segment #1) which is designated as the selected printhead segment 415.

As with the method of FIG. 6, a translate printhead step 220 is used to translate the printhead 30 relative to a receiver medium 32 in the cross-track direction such that the designated printhead segment 215 of the printhead 30 is aligned with a receiver medium region 305 on the receiver medium 32 where the image content 225 is to be printed. A print image content step 230 is then used to print the image content 225 from the image source 22 to produce printed image content 235 on the receiver medium 32.

An image quality acceptable test 420 is then used to assess the image quality of the printed image content 235 to determine whether or not it is acceptable. In some embodiments, this step can be performed by an operator visually inspecting the printed image content 235. In other embodiments, the printed image content 235 can be scanned and automatically analyzed to determine wither the image quality is acceptable. In some configurations, test target data 250 similar that shown in FIG. 9 can be printed periodically and used to evaluate whether the image quality is acceptable.

If the image quality acceptable test 420 determines that the image quality is acceptable, then printing can continue using the currently selected printhead segment 415. If the image quality acceptable test 420 determines that the image quality is unacceptable, a more printhead segments test 435 is used to determine whether there are any remaining printhead segments that can be used. If so, a select new printhead segment step 425 is used to select a new printhead segment (e.g., the next printhead segment in the sequence of printhead segments 405). If not, the printhead must be serviced using a service printhead step 430 (e.g., by cleaning or replacing the printhead).

The approach shown in FIG. 13 systematically utilizes each of the printhead segments 405 of the printhead 30 until the selected printhead segment 415 no longer provides acceptable image quality.

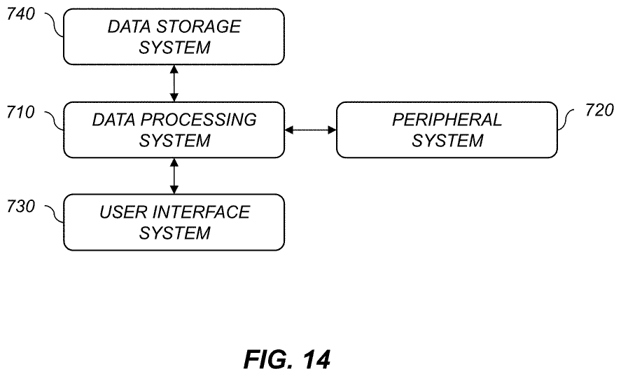

FIG. 14 is a high-level diagram showing the components of a system for processing data according to embodiments of the present invention. The system includes a data processing system 710, a peripheral system 720, a user interface system 730, and a data storage system 740. The peripheral system 720, the user interface system 730 and the data storage system 740 are communicatively connected to the data processing system 710.

The data processing system 710 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, or any other device for processing data, managing data, or handling data, whether implemented with electrical, magnetic, optical, biological components, or otherwise. In some embodiments, the data processing system 710 a plurality of data processing devices distributed throughout various components of the printer system.

The data storage system 740 includes one or more processor-accessible digital memories configured to store information, including the information needed to execute the processes of the various embodiments of the present invention, including the example processes described herein. The data storage system 740 may be a distributed processor-accessible memory system including multiple processor-accessible digital memories communicatively connected to the data processing system 710 via a plurality of computers or devices. On the other hand, the data storage system 740 need not be a distributed processor-accessible digital memory system and, consequently, may include one or more processor-accessible digital memories located within a single data processor or device. The data storage system 740 can be used to store instructions (e.g., computer programs) configured to cause the data processing system 710 to perform specified processes (e.g., image processing algorithms, printing image data, etc.). The data storage system 740 can also be used to store various types of data (e.g., digital image data, algorithm parameters, etc.).

The phrase “processor-accessible digital memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. The phrase “communicatively connected” is intended to include a connection between devices or programs within a single data processor, a connection between devices or programs located in different data processors, and a connection between devices not located in data processors at all. In this regard, although the data storage system 740 is shown separately from the data processing system 710, one skilled in the art will appreciate that the data storage system 740 may be stored completely or partially within the data processing system 710. Further in this regard, although the peripheral system 720 and the user interface system 730 are shown separately from the data processing system 710, one skilled in the art will appreciate that one or both of such systems may be stored completely or partially within the data processing system 710.

The peripheral system 720 may include one or more devices configured to provide digital content records to the data processing system 710. For example, the peripheral system 720 may include printheads, sensors (e.g., ink pressure sensors), pumps, image capture devices, or other data processors. The data processing system 710, upon receipt of digital content records from a device in the peripheral system 720, may store such digital content records in the data storage system 740.

The user interface system 730 may include a mouse, a keyboard, another computer, or any device or combination of devices from which data is input to the data processing system 710. In this regard, although the peripheral system 720 is shown separately from the user interface system 730, the peripheral system 720 may be included as part of the user interface system 730.

The user interface system 730 also may include a display device, a processor-accessible memory, or any device or combination of devices to which data is output by the data processing system 710. In this regard, if the user interface system 730 includes a processor-accessible memory, such memory may be part of the data storage system 740 even though the user interface system 730 and the data storage system 740 are shown separately in FIG. 14.

A computer program product for performing aspects of the present invention can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations, combinations, and modifications can be effected by a person of ordinary skill in the art within the spirit and scope of the invention.

### PARTS LIST

20 printer system
22 image source
24 image processing unit
26 control circuits
27 synchronization device
28 drop forming transducer
30 printhead
32 print medium
34 print medium transport system
35 speed measurement device
36 media transport controller
38 micro-controller
40 ink reservoir
44 ink recycling unit
46 ink pressure regulator
47 ink channel
48 jetting module
49 nozzle plate
50 nozzle
51 heater
52 liquid stream
54 drop
55 drop formation waveform source
57 trajectory
59 breakoff location
60 drop formation waveform
61 charging device
62 charging electrode
62′ charging electrode
63 charging electrode waveform source
64 charging electrode waveform
66 printing drop
68 non-printing drop
69 drop selection system
70 deflection mechanism
71 deflection electrode
72 ink catcher
74 catcher face
76 ink film
78 liquid channel
79 lower plate
80 charging electrode waveform period
82 first voltage state
84 second voltage state
86 non-print trajectory
88 print dot
92-1 drop formation waveform
92-2 drop formation waveform
92-3 drop formation waveform
94-1 drop formation waveform
94-2 drop formation waveform
94-3 drop formation waveform
94-4 drop formation waveform
96 period
98 pulse
100 period
102 pulse
104-1 large drop
104-2 large drop
104-3 large drop
106-1 small drop
106-2 small drop
106-3 small drop
106-4 small drop
108 phase shift
112 printhead assembly
116 in-track direction
118 cross-track direction
132 printing region
134 overlap region
138 nozzle array spacing
140 jetting module
142 nozzle array
200 characterize printhead step
205 image quality function
210 designate printhead segment step
215 printhead segment
220 translate printhead step
225 image content
230 print image content step
235 printed image content
250 test target data
251 flatfield test pattern
252 single pixel wide line test pattern
253 alignment marks
254 segment labels
255 print test target step
260 printed test target
265 capture digital image step
270 captured digital image
275 analyze captured digital image step
280 visually evaluate printed test target step
285 enter image quality information step
300 translation mechanism
305 receiver medium region
350 user interface
355 check box
400 designate printhead segments step
405 printhead segments
410 select initial printhead segment step
415 selected printhead segment
420 image quality acceptable test
425 select new printhead segment step
430 service printhead step
435 more printhead segments test
710 data processing system
720 peripheral system
730 user interface system
740 data storage system

1. A continuous inkjet printer, comprising:
a linear printhead having an array of ink nozzles extending in a cross-track direction;
a receiver medium transport system for transporting a receiver medium past the linear printhead in an in-track direction;
a translation mechanism for translating the linear printhead relative to the receiver medium in the cross-track direction;
an image source providing image content to be printed, the image content to be printed having a cross-track image width;
a data processing system; and
a memory system communicatively connected to the data processing system and storing instructions configured to cause the data processing system to implement a method for controlling the continuous inkjet printer, wherein the method includes:
a) characterizing the linear printhead to determine an image quality level as a function of cross-track position, wherein the linear printhead has a cross-track printhead width that is wider than the cross-track image width of the image content to be printed;
b) designating a segment of the linear printhead having a cross-track segment width at least as large as the cross-track image width of the image content to be printed, wherein the image quality level within the designated segment of the linear printhead is acceptable;
c) using the translation mechanism to translate the linear printhead relative to the receiver medium to align the designated segment of the linear printhead with a region on the receiver medium where the image content is to be printed; and
d) controlling the linear printhead and the receiver medium transport system to print the image content provided by the image source on the receiver medium using the designated segment of the linear printhead.

2. The continuous inkjet printer of claim 1, wherein characterizing the linear printhead includes:
i) providing digital image data for a test target;
ii) printing the test target using the linear printhead;
iii) capturing a digital image of the printed test target; and
iv) automatically analyzing the captured digital image to determine the image quality level as a function of cross-track position.

3. The continuous inkjet printer of claim 2, wherein the test target includes a flatfield test pattern, and wherein the step of automatically analyzing the captured digital image includes determining a magnitude of local variations in the captured digital image, wherein the magnitude of local variations in the captured digital image correspond to a measurement of an image quality level in the captured digital image.

4. The continuous inkjet printer of claim 2, wherein the test target includes a plurality of lines, each printed with a single ink nozzle, and wherein the step of automatically analyzing the captured digital image includes detecting missing lines, misplaced lines or jagged lines.

5. The continuous inkjet printer of claim 2, wherein the test target includes barcode patterns at different cross-track positions, and wherein the step of automatically analyzing the captured digital image includes verifying that the barcode patterns can be accurately read to extract the encoded information.

6. The continuous inkjet printer of claim 1, wherein characterizing the linear printhead includes:
i) providing digital image data for a test target;
ii) printing the test target using the linear printhead;
iii) visually evaluating the printed test target to assess image quality level as a function of cross-track position; and
iv) using a user interface to enter information providing an indication the assessed image quality level as a function of cross-track position;
wherein the steps iii) and iv) are performed by a user.

7. The continuous inkjet printer of claim 6, wherein the printed test target includes a plurality of regions corresponding to different printhead segments, each printhead segment having an associated cross-track position, wherein step iii) includes identifying any printhead segments having an unacceptable image quality level, and wherein step iv) includes entering information providing an indication of the identified printhead segments having an unacceptable image quality level.

8. The continuous inkjet printer of claim 6, wherein the printed test target includes a plurality of regions corresponding to different printhead segments, each printhead segment having an associated cross-track position, wherein step iii) includes identifying a printhead segment having an acceptable image quality level, and wherein step iv) includes entering information providing an indication of the identified printhead segment having an acceptable image quality level.

9. The continuous inkjet printer of claim 6, wherein step iii) includes identifying any cross-track positions having an unacceptable image quality level, and wherein the user interface enables the user to enter information providing an indication of the identified cross-track positions having an unacceptable image quality level.

10. The continuous inkjet printer of claim 1, wherein the translation mechanism translates the linear printhead.

11. The continuous inkjet printer of claim 1, wherein the translation mechanism translates the receiver medium.

12. The continuous inkjet printer of claim 1, wherein steps a)-d) are repeated when it is determined that printed image content has an unacceptable image quality.

13. The continuous inkjet printer of claim 12, wherein the printed image content is determined to have an unacceptable image quality by a human operator viewing the printed image content.

14. The continuous inkjet printer of claim 12, wherein the printed image content is determined to have an unacceptable image quality by capturing a digital image of the printed image content and automatically analyzing the captured digital image.

15. The continuous inkjet printer of claim 1,
wherein steps a)-d) are repeated at predefined time intervals.

16. The continuous inkjet printer of claim 1,
wherein the translation mechanism is a leadscrew mechanism.

17. A continuous inkjet printer, comprising:
a linear printhead having an array of ink nozzles extending in a cross-track direction;
a receiver medium transport system for transporting a receiver medium past the linear printhead in an in-track direction;
a translation mechanism for translating the linear printhead relative to the receiver medium in the cross-track direction;
an image source providing image content to be printed, the image content to be printed having a cross-track image width;
a data processing system; and
a memory system communicatively connected to the data processing system and storing instructions configured to cause the data processing system to implement a method for controlling the continuous inkjet printer, wherein the method includes:
a) characterizing the linear printhead to determine an image quality level as a function of cross-track position, wherein the linear printhead has a cross-track printhead width that is wider than the cross-track image width of the image content to be printed;
b) designating a segment of the linear printhead having a cross-track segment width at least as large as the cross-track image width of the image content to be printed, wherein the image quality level within the designated segment of the linear printhead is acceptable; and
c) using the translation mechanism to translate the linear printhead relative to the receiver medium to align the designated segment of the linear printhead with a region on the receiver medium where the image content is to be printed;
wherein characterizing the linear printhead includes:
i) providing digital image data for a test target;
ii) printing the test target using the linear printhead;
iii) capturing a digital image of the printed test target; and
iv) automatically analyzing the captured digital image to determine the image quality level as a function of cross-track position; and
wherein the step of automatically analyzing the captured digital image includes determining a magnitude of local variations in the captured digital image, such that the magnitude of local variations in the captured digital image correspond to a measurement of an image quality level in the captured digital image.
